(19) United States
(12) Patent Application Publication
(10) Pub. No.: US 2007/0002395 A1
(43) Pub. Date: Jan. 4, 2007

(54) Scanning apparatus

(75) Inventor: In-sik Seo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics, Co., Ltd, Suwon-si (KR)

(21) Appl. No.: 11/385,768

(22) Filed: Mar. 22, 2006

(30) Foreign Application Priority Data
Jun. 29, 2005 (KR) 2005-57205
Jun. 29, 2005 (KR) 2005-57247

(51) Int. Cl. H04N 1/04

(52) U.S. Cl. 358/474

(57) ABSTRACT

A scanning apparatus including a scanner body that has a document bed on which a document is placed; a scan unit that is movably disposed in the inside of the scanner body and scans the document placed on the document bed; and a light-blocking unit that selectively covers a non-image area on the document bed where the document is not placed. With the scanning apparatus of the present invention, it is possible to prevent unnecessary consumption of a developer and exposure of light from the scan unit as resulting from scanning the non-image area.

### CROSS-REFERENCE TO RELATED APPLICATIONS

This application claims the benefit of Korean Application Patent Nos. 2005-57205 and 2005-57247, 2005, both filed Jun. 29, 2005, in the Korean Intellectual Property Office, the disclosure of which is incorporated herein by reference.

### BACKGROUND OF THE INVENTION

1. Field of the Invention

Aspects of the present invention relate to a composite apparatus that has the functions of a scanner, a printer and a facsimile machine, and more particularly, a scanning apparatus for scanning an image of a document.

2. Description of the Related Art

In general, a composite apparatus scans and stores an image of a document and prints or transmits the stored image. The composite apparatus comprises a scanning apparatus for scanning the image of the document. FIG. 1 schematically shows an example of the scanning apparatus, which will be briefly described below.

As shown in FIG. 1, the composite apparatus comprises a scanner body 1 and a scanning unit 2. The scanner body 1 has a document bed 1a where a document P is placed, and the scanning unit 2 scans the document P.

The composite apparatus further comprises a cover (not shown) that covers the document bed 1a, on which the document P is placed for scanning.

The scan unit 2 is movably disposed in the inside of the scanner body 1 and scans an image of the document P placed on the document bed 1a.

In the scan unit 2, a scanning area is set up according to a predefined size, for example, A4 or A3, of the document placed on the document bed 1a. Specifically, as shown in FIG. 1, if the paper size of the document is set to A4, the scan unit 2 moves to scan the area indicated by the arrow A1. If the paper size of the document is set to A3, the scan unit 2 moves to scan the area indicated by the arrow A2.

When the image of a non-standard size document, such as small-sized books, is to be scanned, there is an area on the document bed which is scanned by the scan unit but not covered by the document, since the scan unit 2 can scan only the defined standard areas of A1 and A2. This non-image area is unnecessarily scanned by the scan unit since the document does not get scanned at all.

The non-image area is printed in black when the scanning apparatus performs the scanning operation with its cover opened due to a thickness of the non-standard size document. This not only deteriorates the quality of the image but also causes unnecessary ink use of a printer, since the printer will print out the dark “non-image area” of the scanned document.

Moreover, the light of the scan unit 2 is exposed outwardly through the non-image area due to the open cover. This exposure can give a user an unpleasant feeling, which may consequently have a negative impact on the user's perception of the product's quality and reliability.

### SUMMARY OF THE INVENTION

Accordingly, one aspect of the present invention to provide a scanning apparatus comprising a light-blocking unit that is capable of selectively covering a non-image area of a document bed where a document is not placed.

Additional aspects and/or advantages of the invention will be set forth in part in the description which follows and, in part, will be obvious from the description, or may be learned by practice of the invention.

The above and/or other aspects of the present invention are substantially realized by providing a scanning apparatus comprising a scanner body that has a document bed where a document is placed, a scan unit that is movably disposed inside the scanner body; and a light-blocking unit that selectively covers an area on the document bed which is scanned by the scan unit and not covered by the document.

According to a first embodiment of the present invention, the light-blocking unit may comprise a first light-blocking membrane and a second light-blocking membrane, which are arranged to move in directions orthogonal to each other on the document bed to cover the non-image area.

Preferably, the first and second light-blocking membranes may be arranged at different heights with respect to the document bed, so that these membranes do not interfere with each other during movement.

Preferably, the first and second light-blocking membranes may be arranged to come in and out of the inside of the scanner body, and a handle may be provided at the front end of each light-blocking membrane. Also preferably, a guide rail that guides each of the first and second light-blocking membranes to come in and out is arranged in the inside of the scanner body.

Further, according to a second embodiment of the present invention, the first and second light-blocking membranes are made of an expandable and contractible material, each of which has a fixed end at the upper edge of the scanner body and a free end that is expandable and contractible from the fixed end.

A handle is placed at the free end of each of the first and second light-blocking membranes. A fixing member for maintaining contracted states of the first and second light-blocking membranes is disposed in the scanner body where the fixed end is fixed.

The fixing member is made of a magnet, and the handle has a fixing portion that corresponds to the magnet. Preferably, the fixing portion may be integrally formed into the handle.

Further, according to a third embodiment of the present invention, the scanning apparatus may comprise a first storing reel and a second storing reel used to store the first light-blocking membrane and the second light-blocking membrane by elastically winding these membranes on the reels respectively; and a holding unit used to keep the non-image area covered by the first and second light-blocking membranes.

Preferably, the holding unit may comprise a handle at the front end of each of the first and second light-blocking membranes and a number of fixing grooves at the upper, lower, left and right sides of the upper surface of the scanner body, which are used to fix a movement position of the handle on the document bed.

Preferably, the first and second storing reels may be disposed in the inside of the scanner body.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic plane view of a general scanning apparatus;

FIG. 2 is a schematic plane view of a scanning apparatus according to a first embodiment of the present invention;

FIG. 3 is a schematic plane view showing the operation of a light-blocking unit, which is an essential component of the present invention;

FIG. 4A is a cross-sectional view as taken along the line IV-IV of FIG. 3;

FIG. 4B is a schematic cross-sectional view showing a state that the cover of FIG. 4A is closed;

FIG. 5 is a cross-sectional view as taken along the line V-V of FIG. 3;

FIG. 6 is an enlarged cross-sectional view of the essential component as taken along the line VI-VI of FIG. 4A;

FIG. 7 is a schematic plane view of a scanning apparatus according to a second embodiment of the present invention;

FIG. 8 is a cross-sectional view as taken along the line VIII-VIII of FIG. 7;

FIG. 9 is an enlarged view of part E of FIG. 8;

FIG. 10 is a schematic plane view of a scanning apparatus according to a third embodiment of the present invention;

FIG. 11 is a cross-sectional view as taken along the line XI-XI of FIG. 10;

FIG. 12 is a cross-sectional view as taken along the line XII-XII of FIG. 10; and

FIG. 13 is a cross-sectional view as taken along the line XIII-XIII of FIG. 10.

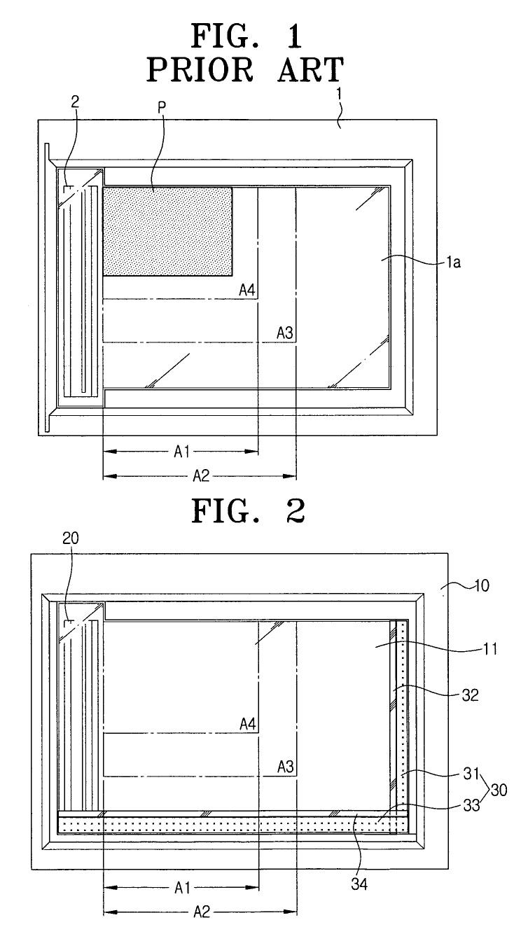

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

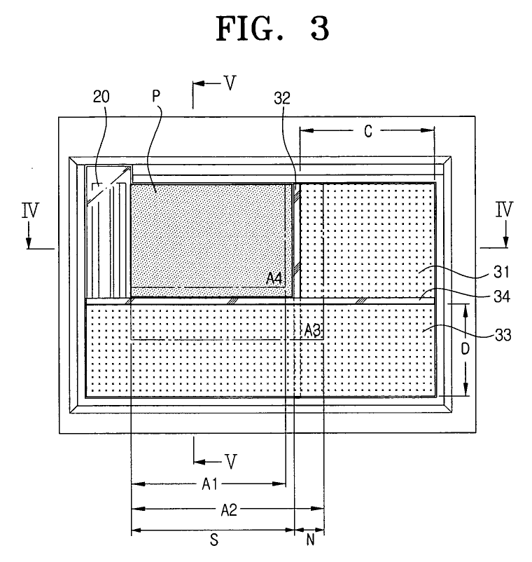

As shown in FIGS. 2 and 3, a scanning apparatus according to a first embodiment of the present invention comprises a scanner body 10, a scan unit 20 and a light-blocking unit 30.

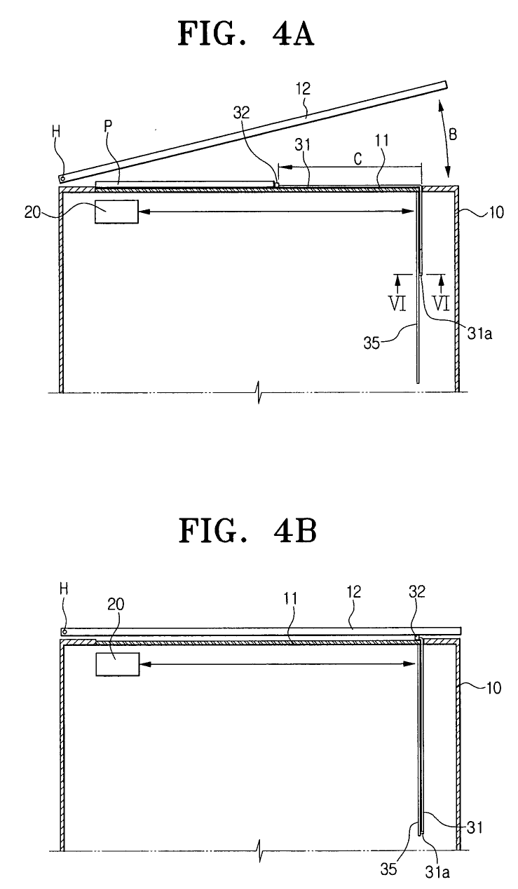

The scanner body 10 includes a transparent flat document bed 11 on which a document P is placed. As shown in FIG. 4A, a cover 12 is disposed on the scanner body 10, which is opened on a hinge H in the direction indicated by the arrow B to reveal the document bed 11.

As shown in FIGS. 4A and 4B, the scan unit 20 is movably disposed in the inside of the scanner body 10, to scan the image of the document P placed on the document bed 11.

In the scan unit 20, a scanning area is set according to a predefined standard size, for example, A4 or A3, of the document P placed on the document bed 11, as shown in FIGS. 2 and 3. Specifically, if the A4 size is selected for the document, the scan unit 20 moves to scan the area indicated by the arrow A1. If the A3 size is selected, the scan unit 20 moves to scan the area indicated by the arrow A2.

The scan unit 20 comprises an optical sensor, such as a contact image sensor (CIS) or a charge coupled device (CCD), which irradiates light onto the document P and senses the light reflected from the document P. Such technical composition of the scan unit 20 can be easily understood from the well-known prior art, and thus, further description will not be presented here.

The light-blocking unit 30 comprises a first light-blocking membrane 31 and a second light-blocking membrane 33 and selectively covers a non-image area N of the document bed 11, where the document P is not placed.

As shown in FIG. 3, if the non-standard size document P that is smaller than the standard size, such as A4 or A3, is placed on the document bed 11, the scan unit 20 moves to scan the predetermined Al or A2 area. The non-image area N refers to the scanned area that is not the image area S where the document P is placed.

In the first embodiment, the document P whose size is smaller than A4 and bigger than A3 is placed on the document bed 11, as shown in FIG. 3.

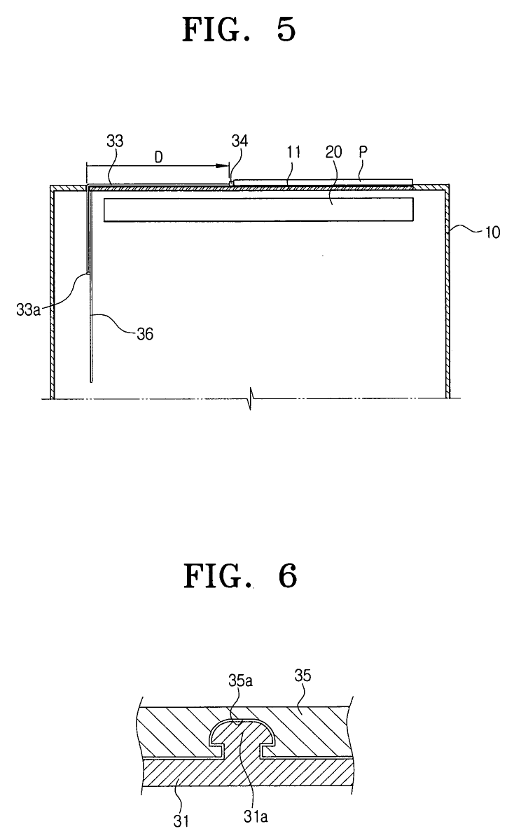

As shown in FIG. 3, the first and second light-blocking membranes 31 and 33 cover the non-image area N by moving in the directions orthogonal to each other on the document bed. Specifically, as shown in FIGS. 3 and 4A, the first light-blocking membrane 31 covers the non-image area N horizontally by moving in the direction indicated by the arrow C on the document bed 11. As shown in FIGS. 3 and 5, the second light-blocking membrane 33 vertically covers the non-image area N on the document bed 11 by moving in the direction indicated by the arrow D, which is orthogonal to the direction C. In the first embodiment, the first and second light-blocking membranes 31 and 33 are made out of various materials such as fabrics for general curtains or blinds, resins or plastics.

The first and second light-blocking membranes 31 and 33 are disposed at different heights with respect to the document bed 11 so that the two light-blocking membranes do not block each other's movement. In this first embodiment, it is illustrated that the first light-blocking membrane 31 is positioned lower than the second light-blocking membrane 33. Thus, after the first light-blocking membrane 31 is moved in the direction indicated by the arrow C, the second light-blocking membrane 33 is moved in the direction indicated by the arrow D. However, the height positions of the first and second light-blocking membranes 31 and 33 are not limited as illustrated in the drawing.

As shown in FIGS. 4A, 4B and 5, the first and second light-blocking membranes 31 and 33 are arranged to come in and out of the inside of the scanner body 10. A first handle 32 and a second handle 34 are placed at the front ends of the first light-blocking membrane 31 and the second light-blocking membrane 33, respectively. The first and second handles 32 and 34 are used to determine the positions of the first and second light-blocking membranes 31 and 33 as a user holds the handles and selectively moves the first and second light-blocking membranes 31 and 33.

As shown in FIGS. 4A and 5, a first guide rail 35 and a second guide rail 36 guide the first and second light-blocking membranes 31 and 33, respectively, to smoothly come in and out of the inside of the scanner body 10.

The first and second guide rails 35 and 36 are arranged in the inside of the scanner body 10. However, the positions of the first and second guide rails 35 and 36 are not limited as illustrated in the drawing. For instance, the first and second guide rails 35 and 36 may be placed at one exterior side of the scanner body 10 or in any number of other places on or near the scanner body 10 and achieve successful results.

The first and second light-blocking membranes 31 and 33 guided by the first and second guide rails 35 and 36, respectively, include a first protrusion 31a and a second protrusion 33a, which are used to lock the stopping position of the first and second light-blocking membranes 31 and 33.

As shown in FIG. 6, the first and second protrusions 31a and 33a are movably inserted in grooves 35a located in the first and second guide rails 35 and 36. A plurality of the grooves are formed in the first and second guide rails 35 and 36, so that the inserted first and second protrusions 31a and 33a lock the positions of the first and second light-blocking membranes 31 and 33 when the two light-blocking membranes 31 and 33 stop without interrupting their movements.

The first and second protrusions 31a and 33a are formed at the back ends of the first and second light-blocking membranes 31 and 33, respectively. Here, the positions of the first and second protrusions 31a and 33a are not limited as illustrated in the drawing. In other words, the first and second protrusions 31a and 33a may be arranged at any positions of the first and second light-blocking membranes 31 and 33 so that they are able to be caught in the first and second guide rails 35 and 36.

The operation of the scanning apparatus in the above-described configuration according to the first embodiment of the present invention will be described with reference to the accompanying drawings below.

As shown in FIGS. 2 and 4B, only the first and second handles 32 and 34 of the first and second light-blocking membranes 31 and 33 are arranged outside the scanner body 10 before the document P is placed on the document bed 11. Specifically, the first and second handles 32 and 34 are positioned at the boundary of the document bed 11 and the scanner body 10.

Here, the first and second light-blocking membranes 31 and 33 are positioned in the inside of the scanner body 10, without being exposed on the upper surface of the document bed 11. The first and second light-blocking membranes 31 and 33 are fixed as the first and second protrusions 31a and 33a are caught in the first and second guide rails 35 and 36, respectively.

The cover 12 of the document bed 11 is opened on a hinge H in the direction indicated by the arrow B as shown in FIG. 4A, and a document P is placed on the document bed 11 as shown in FIG. 3. Here, the document P is bigger than the A4 size and smaller than the A3 size and also has a predetermined thickness.

Before scanning the image of the document P, the user moves the first and second handles 32 and 34 in the directions indicated by the arrows C and D, respectively, as shown in FIGS. 3, 4A and 5, so that the first and second light-blocking membranes 31 and 33 come into contact with the document P. The first and second guide rails 35 and 36 guide the movements of the first and second light-blocking membranes 31 and 33, respectively. Further, as shown in FIG. 6, the positions of the first and second light-blocking membranes 31 and 33 are fixed as the first and second protrusions 31a and 33a are inserted and caught in the grooves 35a of the first and second guide rails 35 and 36, respectively.

Since the first and second light-blocking membranes 31 and 33 cover the non-image area N on the document bed in the above manner, the light of the scan unit 20 in operation is not exposed through the non-image area N, which subsequently prevents the image from being printed in black.

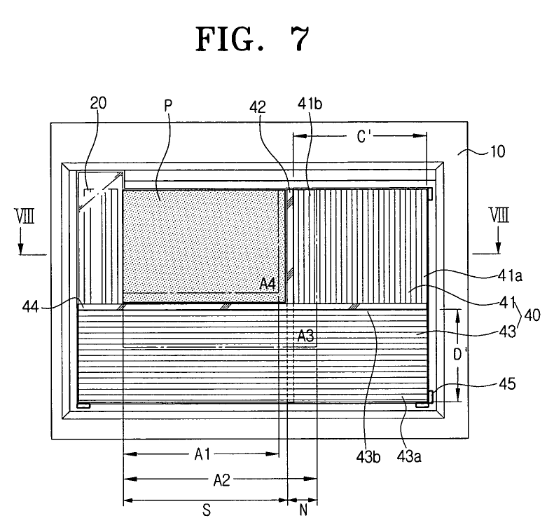

As shown in FIG. 7, a scanning apparatus according to a second embodiment of the present invention comprises a scanner body 10, a scan unit 20 and an light-blocking unit 40, also referred to as a light-blocking unit. The technical composition of the scanner body 10 and the scan unit 20 of the scanning apparatus according to the second embodiment is similar to the composition according to the first embodiment of the present invention as illustrated in FIGS. 2, 3, 4A, 4B and 5. The same reference numbers as those used in the first embodiment will be given to the scanner body 10 and the scan unit 20, and further description thereof will not be presented herein. Below, only the distinctive configuration of the second embodiment will be described.

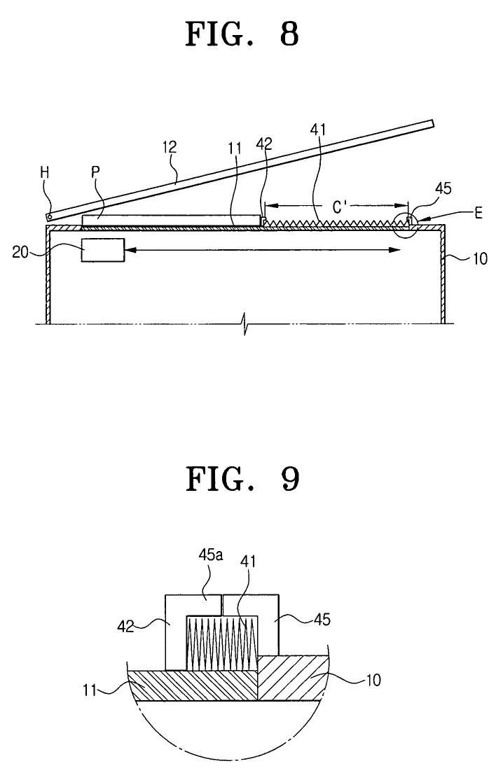

In accordance with the technical composition of the present invention, the light-blocking unit 40 comprises a first light-blocking membrane 41 and a second light-blocking membrane 43 as in the first embodiment. However, the difference is in the fact that the first and second light-blocking membranes 41 and 43 are made of elastic membranes as shown in FIG. 8. In the second embodiment, the first and second light-blocking membrane 41 and 43 are made out of flexible materials that can be expanded and folded from a position like an ordinary foldable bellows.

Different from the first embodiment, the first and second light-blocking membranes 41 and 43 do not come in and out of the inside of the scanner body 10. Instead, the first and second light-blocking membranes 41 and 43 include a first fixing end 41a and a second fixing end 43a, respectively, that are fixed on the edges of the upper surface of scanner body 10. The first and second light-blocking membranes 41 and 43 also have a first free end 41b and a second free end 43b that are expandable and contractible from the first and second fixing ends 41a and 43a, respectively. The first and second free ends 41b and 43b of the first and second light-blocking membranes 41 and 43 are expanded and contracted in the directions indicated by the arrows C′ and D′ with respect to the first and second fixing ends 41a and 43a, respectively, as shown in FIGS. 7 and 8.

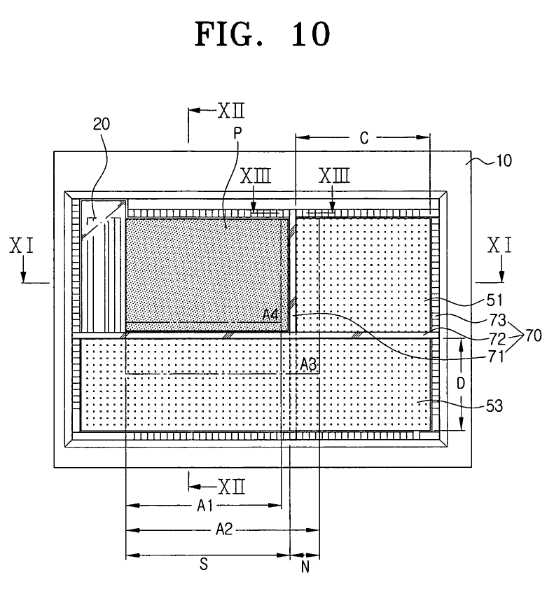

As in the first embodiment, a first handle 42 and a second handle 44 are placed at the front ends of the first and second light-blocking membranes 41 and 43 which are made of elastic materials, i.e., at the first and second free ends 41b and 43b, respectively. As a user moves the first and second handles 42 and 44 selectively, how much the first and second light-blocking membranes 41 and 43 are expanded and contracted is determined. In the second embodiment, different from the first embodiment, a fixing member 45 is disposed at the scanner body 10 on which the first and second fixing ends 41a and 43a are fixed to maintain the contraction of the first and second light-blocking membranes 41 and 43. It is preferable that the fixing member 45 is made of a magnet. Each of the first and second handles 42 and 44 has the fixing portion 45a that corresponds to the magnetic fixing member 45 as shown in FIG. 9. The fixing portions 45a are integrally formed into each of the first and second handles 42 and 44, respectively. In this second embodiment, the first and second handles 42 and 44 are made of materials, such as metals, which can be fixed on the magnetic fixing member 45.

In the second embodiment, the first and second light-blocking membranes 41 and 43 are preferably elastic membranes, such as ordinary foldable bellows that are expandable and contractible, but the light-blocking membranes are not limited to this. There are many different types of flexible materials that the first and second light-blocking membranes 41 and 43 could be made of which would still achieve desirable results.

Since the light-blocking unit 40 is made of foldable materials that are expandable and contractible, it can stay on top of the document bed 11 at all times, and therefore do not interfere with the scanner parts housed within the scanner body 10.

As shown in FIGS. 10, 11, 12 and 13, the scanning apparatus according to a third embodiment of the present invention comprises a scanner body 10, a scan unit 20, an light-blocking unit 50 first and second storing reels 61 and 62 and a holding unit 70. The technical composition of the scanner body 10 and the scan unit 20 of the scanning apparatus according to the third embodiment is similar to their composition according to the first embodiment of the present invention illustrated in FIGS. 2, 3, 4A, 4B and 5. Thus, as in the second embodiment, the reference numbers identical to those used in the first embodiment are given to the scanner body 10 and the scan unit 20, and further description of them will not be presented here.

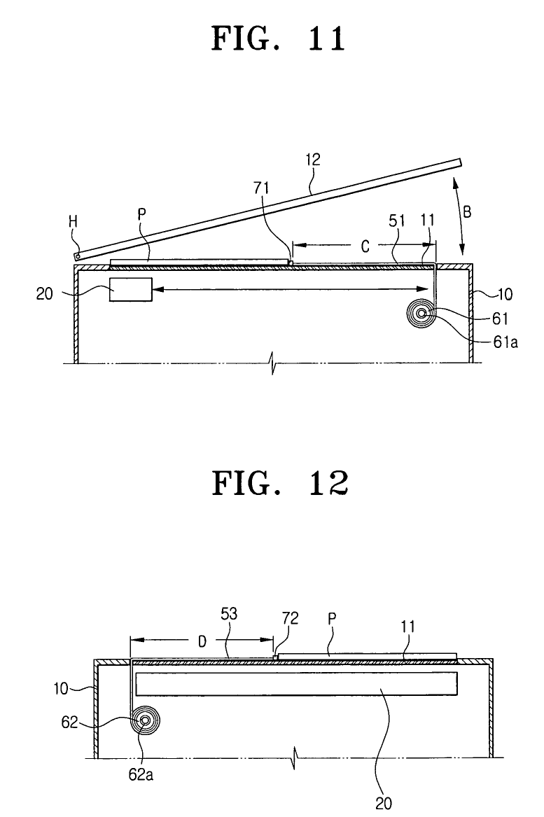

In accordance with the technical composition of the present invention, a first light-blocking membrane 51 and a second light-blocking membrane 53 of the light-blocking unit 50 are elastically wound on a first storing reel 61 and a second storing reel 62, as shown in FIGS. 11 and 12. A first elastic membrane 61a and a second elastic membrane 62a provide elasticity to the first and second light-blocking membranes 51 and 53 in the direction in which the light-blocking membranes are wound by the first and second storing reels 61 and 62.

In this third embodiment, the first and second storing reels 61 and 62 are housed within the inside of the scanner body 10. However, the positions of the first and second storing reels 61 and 62 are not limited to this configuration. There are many different ways to attach the first and second storing reels 61 and 62 to the scanner body 10, such as at one internal side of the scanner body 10.

The holding unit 70 holds the first and second light-blocking membranes 51 and 53 in position. It comprises a first handle 71, a second handle 72 and a fixing groove 73. The first and second handles 71 and 72 are the same handles described in the first and second embodiments.

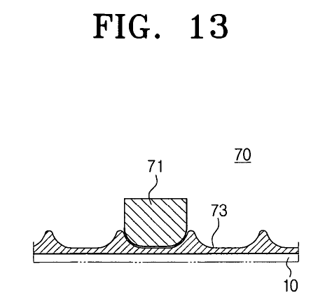

The first and second handles 71 and 72 are provided at the front ends of the first and second light-blocking membranes 51 and 53, respectively. A plurality of fixing grooves 73 are formed on the upper, lower, left and right sides of the upper surface of the scanner body 10, as shown in FIG. 10. The grooves 73 fix the movement positions of the first and second handles 71 and 72 on the document bed 11, as shown in FIG. 13.

In this third embodiment, although the grooves 73 are illustrated as being formed on the upper surface of the scanner body 10 and exposed outwardly, the positions of the grooves 73 should not be limited as illustrated in FIG. 13. A variation of the embodiment is possible wherein the guide groove is formed around the upper part of the scanner body 10, and the fixing grooves are made at the inside upper part or lower part of the guide groove so that the fixing grooves cannot be seen from the outside. There are many other ways to position the grooves so that they can hold the first and second handles 71 and 72 in place.

The operation of the aforementioned third embodiment is as follows. When the non-standard standard size document is placed on the document bed 11, the user moves the first and second handles 71 and 72 in the directions indicated by the arrows C and D, respectively. Then, the first and second light-blocking membranes 51 and 53, which are elastically wound on the first and second storing reels 61 and 62, respectively, are pulled out of the inside of the scanner body 10 to put the first and second light-blocking membranes 51 and 53 in contact with the document P, as shown in FIGS. 11 and 12. The movement positions of the first and second light-blocking membranes 51 and 53 are determined by fixing the first and second handles 71 and 72 onto the fixing grooves 73, as illustrated in FIG. 13.

Since the first and second light-blocking membranes 51 and 53 are elastically wound on the first and second storing reels 61 and 62 and come in and out of the scanner body 10, it is easy to release the first and second light-blocking membranes 51 and 53 that cover the non-image area N.

In all the embodiments, the underside of each light-blocking membrane is colored white in order to prevent scanning a dark image of the non-image area.

In accordance with aspects of the scanning apparatus of the present invention, the scan unit does not scan through the non-image area since the light-blocking units cover the non-image area of the document bed. Consequently, this prevents part of the image from being printed in black, which is caused by scanning the non-image area, even when the document is scanned without the cover of the scanning apparatus completely closed. This can prevent unnecessary consumption of the printer and enhance the quality of the image.

Furthermore, the light-blocking unit blocks the light of the scan unit from reaching the user through the non-image area because of the opened cover. This can prevent the user from feeling unpleasant due to the light of the scan unit.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A scanning apparatus comprising:
a scanner body that has a document bed where a document is placed;
a scan unit that is movably disposed inside the scanner body; and
a light-blocking unit that selectively covers an area on the document bed which is scanned by the scan unit and not covered by the document.

2. The apparatus of claim 1, wherein the light-blocking unit comprises:
a first light-blocking membrane; and
a second light-blocking membrane, wherein the first and second light-blocking membranes move in directions orthogonal to each other on the document bed.

3. The apparatus of claim 2, wherein the first and second light-blocking membranes are arranged at different heights with respect to the document bed, so that the first and second light-blocking membranes do not block the movement of each other during operation.

4. The apparatus of claim 3, further comprising handles respectively attached to one end of each of the light-blocking membranes, which are used to control the position of the light-blocking membranes.

5. The apparatus of claim 4, further comprising:
guide rails inside the scanner body; and
protrusions on each of the light-blocking membranes, wherein the protrusions are attached to the guide rails to guide the movement of the light-blocking membranes inside the scanner body.

6. The apparatus of claim 3, wherein the first and second light-blocking membranes comprise expandable and contractible material.

7. The apparatus of claim 6, further comprising:
fixed ends fixed to edges of the scanner body and corresponding to the first and second light-blocking membranes; and
free ends respectively attached to each of the first and second light-blocking membranes, wherein the free ends are pullable and pushable to change the position of each of the light-blocking membranes on the document bed.

8. The apparatus of claim 7, further comprising:
handles respectively fastened to the free ends of each of the first and second light-blocking membranes; and
fixing members respectively formed on edges of each of the fixed ends, wherein the handles are releasably attachable with the corresponding fixing members and lock the corresponding membrane in a compressed position when attached to the corresponding fixing end.

9. The apparatus of claim 8, wherein the fixing members are magnetic and the handles contain metal which are magnetically attracted to the corresponding fixing members.

10. The apparatus claim 3, further comprising:
storing reels used to store each of the first and second light-blocking membranes by elastically winding the membranes around the storing reels, respectively;
handles respectively attached at ends of each of the first and second light-blocking membranes; and
fixing grooves which fix a position of the handles on the document bed.

11. The apparatus of claim 10, wherein the fixing grooves are arranged at an upper outer perimeter of the scanner body.

12. The apparatus of claim 10, wherein the first and second storing reels are housed inside the scanner body.

13. The apparatus of claim 11, wherein the first and second storing reels are housed inside the scanner body.

14. The apparatus of claim 10, wherein the first and second storing reels are housed outside of the scanner body.

15. The apparatus of claim 11, wherein the first and second storing reels are housed outside of the scanner body.

16. A scanning apparatus comprising:
a scanner body having a document bed where a document is placed;
a scan unit that is movably disposed in an inside of the scanner body; and
units adjustable according to a size of the document to cause the non-image area of the scan unit uncovered by the document to produce a white image and prevent light of the scanning unit to escape therethrough.

17. The apparatus of claim 16, wherein the units comprise:
a first light-blocking membrane; and
a second light-blocking membrane, wherein the first and second light-blocking membranes move in directions orthogonal to each other on the document bed.

18. The apparatus of claim 17, wherein the first and second light-blocking membranes are arranged at different heights with respect to the document bed, so that the first and second light-blocking membranes do not block the movement of each other during operation.

19. The apparatus of claim 18, further comprising:
handles respectively attached to one end of each of the light-blocking membranes, which are used to control the position of the light-blocking membranes.

20. The apparatus of claim 19, further comprising:
guide rails in the inside of the scanner body; and
protrusions on each of the light-blocking membranes, wherein the protrusions are attached to the guide rails to guide the movement of the light-blocking membranes inside the scanner body.

21. The apparatus of claim 16, wherein the first and second light-blocking membranes comprise expandable and contractible material.

22. The apparatus of claim 21, further comprising:
fixed ends fixed to edges of the scanner body and corresponding to the first and second light-blocking membranes; and
free ends respectively attached to each of the first and second light-blocking membranes, wherein the free ends are pullable and pushable to change the position of each of the light-blocking membranes on the document bed.

23. The apparatus of claim 22, further comprising:
handles respectively fastened to the free ends of each of the first and second light-blocking membranes; and
fixing members respectively formed on edges of each of the fixed ends, wherein the handles are releasably attachable with the corresponding fixing members and lock the corresponding membrane in a compressed position when attached to the corresponding fixing end.

24. The apparatus of claim 23, wherein the fixing members are magnetic and the handles contain metal which are magnetically attracted to the corresponding fixing members.

25. The apparatus of claim 16, further comprising:
storing reels used to store each of the first and second light-blocking membranes by elastically winding the membranes around the storing reels, respectively;
handles respectively attached at ends of each of the first and second light-blocking membranes; and
fixing grooves which fix a position of the handles on the document bed.

26. The apparatus of claim 25, wherein the fixing grooves are arranged at an upper outer perimeter of the scanner body.

27. The apparatus of claim 25, wherein the first and second storing reels are housed inside the scanner body.

28. The apparatus of claim 26, wherein the first and second storing reels are housed inside the scanner body.

29. The apparatus of claim 25, wherein the first and second storing reels are housed outside of the scanner body.

30. The apparatus of claim 26, wherein the first and second storing reels are housed outside of the scanner body.
